(19) United States
(12) Patent Application Publication
(10) Pub. No.: US 2007/0178952 A1
(43) Pub. Date: Aug. 2, 2007

(54) Game apparatus and game program

(75) Inventors: Yui Ehara, Kyoto (JP); Tomoki Yamamoto, Kyoto (JP); Junichi Saito, Kyoto (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 11/641,109

(22) Filed: Dec. 19, 2006

(30) Foreign Application Priority Data
Jan. 27, 2006 (JP) 2006-019864

(51) Int. Cl. A63F 13/00; A63F 9/24; A63F 1/10; G06F 3/16; G06F 3/00

(52) U.S. Cl. 463/1; 715/728; 715/761; 273/150; 463/2

(57) ABSTRACT

A game apparatus includes a first LCD, a second LCD, and a microphone disposed between the first LCD and the second LCD. A computer of the game apparatus displays a game image including an object image on at least one of the first LCD and the second LCD. When sound is detected through the microphone, the computer changes the object image displayed on the first LCD and/or the second LCD.

### CROSS REFERENCE OF RELATED APPLICATION

The disclosure of Japanese Patent Application No. 2006-19864 is incorporated herein by reference.

### BACKGROUND OF THE INVENTION

1. Field of the Invention

The present invention relates to a game apparatus and a game program. More particularly, the present invention relates to a game apparatus and a game program that change a game image according to an input to a microphone, for example.

2. Description of the Related Art

Conventionally, as this type of apparatus or program, there is known one disclosed in an “instruction manual (Jan. 27, 2005) for Nintendo DS game software ‘Catch! Touch! Yoshi!’”. This conventional technique is about a folding type handheld game apparatus having two screens. One of the two screens is provided to an upper housing and the other screen is provided to a lower housing. A game image is displayed on any one of the two screens (a first screen and a second screen), or across the first screen and the second screen.

A microphone is provided diagonally downward left of the screen of the lower housing. When a specific sound wave is detected through the microphone, a change is made to the game image on the screen. Specifically, an image of a cloud is included in the game image and when a player blows his/her breath on the microphone with the cloud being displayed on the screen, the breath, i.e., the flow of air, hits the microphone, whereby a characteristic sound wave is generated and the sound wave is detected through the microphone itself. When the sound wave is thus detected by a blowing of breath, the cloud on the screen moves upward as if the cloud were blown off by the breath.

Generally, as a natural action, the player tends to blow his/her breath on the cloud on the screen instead of on the microphone. Thus, in the conventional technique, particularly when the cloud is displayed near an upper right end of the first screen, breath may not hit the microphone and a sound operation may not be performed. To prevent this, particularly when the cloud is far from the microphone, the player needs to blow his/her breath on the microphone focusing on the microphone and thus can only obtain an unnatural operation feeling.

Not only in a case of performing a sound operation by a blowing of breath but also in a case of performing a sound operation by utterance (generating sound with vocal cords, lips, or the like), particularly when the microphone directivity is high, the same problem may occur.

### SUMMARY OF THE INVENTION

Therefore, it is a principal object of the present invention to provide novel game apparatus and game program.

It is another object of the present invention to provide a game apparatus and a game program which are capable of increasing the accuracy of a sound operation and with which a natural operation feeling can be obtained.

A game apparatus (10: reference numeral corresponding to that used in the embodiment, hereinafter the same) according to a first invention comprises: a first screen (12) and a second screen (14), on at least one of which is displayed a game image including an object image (80, 84); a microphone (34); and a display control means (40, S9) for changing the object image when sound is detected through the microphone, wherein the microphone is provided between the first screen and the second screen.

In the first invention, a game image including an object image is displayed on at least one of the first screen and the second screen. Thus, an object image(s) is (are) displayed on the first screen and/or the second screen. The microphone is located between the first screen and the second screen. When sound is detected through the microphone, the display control means changes the object image(s) displayed on the first screen and/or the second screen.

Although sound is typically a sound wave to be generated by a blowing of breath on the microphone, sound may be a sound wave to be generated by utterance. When the game image further includes a background image (82, 86), the background image is also displayed on the first screen and/or the second screen; however, no change is made to the background image or a change is made to the background image, regardless of detection of a specific sound wave.

Detection of sound includes detection of a specific sound wave (voice recognition, recognition of a blowing of breath, or the like) and detection of a non-specific sound wave (e.g., detection of only sound volume without detecting the type of sound).

The display control means controls an object to move, controls an object to perform a predetermined action, or controls the display mode of an object to change, for example.

According to the first invention, by disposing the microphone between the first screen and the second screen, the distance between an object(s) displayed on the first screen and/or the second screen and the microphone is reduced; thus, the possibility that detection of sound may become difficult depending on the display location of the object(s) can be reduced and the accuracy of a sound operation improves. As a result, a player can perform a sound operation, such as blowing breath or giving utterance, without focusing attention on the microphone, and thus, can obtain a natural operation feeling.

A game apparatus according to a second invention depends from the first invention, and the display control means may change the object image when a specific sound wave is detected through the microphone.

A game apparatus according to a third invention depends from the first invention, and may further comprise an object display means for displaying objects on both of the first screen and the second screen, and the display control means may change both the object image displayed on the first screen and the object image displayed on the second screen, when the sound is detected.

A game apparatus according to a fourth invention depends from the second invention, and the specific sound wave may be a sound wave to be generated by a blowing of breath on the microphone.

In the fourth invention, a specific sound wave is generated by a blowing of breath on the microphone and the generated specific sound wave is detected through the microphone itself, in response to which the processing of the display control means is performed.

A game apparatus according to a fifth invention depends from the fourth invention, and the first screen and the second screen may be disposed in order of the second screen and the first screen along a specific direction (x). When the display control means detects the specific sound wave through the microphone, the display control means may move or accelerate the object image displayed on the first screen in the specific direction and move or accelerate the object image displayed on the second screen in a direction opposite to the specific direction.

A game apparatus according to a sixth invention depends from the first invention, and may further comprise a storage means (48), a virtual game space display means (S41), an object movement control means (S43), and an object display control means (S47, S49). The storage means stores display data for a virtual game space. The virtual game space display means displays the virtual game space across the first screen and the second screen, based on the display data. The object movement control means controls movement of an object in the virtual game space. The object display control means displays the object image on the first screen when the object is present in a display area of the first screen in the virtual game space, and displays the object image on the second screen when the object is present in a display area of the second screen.

A game apparatus according to a seventh invention depends from the first invention, and the first screen (12) and the second screen (14) may be disposed in order of the second screen and the first screen along a specific direction (x). The display control means may include a first determination means (S23), a first movement means (S25), a second determination means (S27), and a second movement means (S29).

The first determination means determines, when the sound is detected through the microphone, whether at least part of the object image is displayed on the first screen. The first movement means moves or accelerates, when it is determined by the first determination means that at least part of the object image is displayed on the first screen, the object image displayed on the first screen in the specific direction.

The second determination means determines, when the sound is detected, whether at least part of the object image is displayed on the second screen. The second movement means moves or accelerates, when it is determined by the second determination means that at least part of the object image is displayed on the second screen, the object image displayed on the second screen in a direction opposite to the specific direction.

In the seventh invention, when sound is detected through the microphone provided between the first screen and the second screen, a determination processing of the first determination means and a determination processing of the second determination means are performed. If it is determined by the first determination means that at least part of an object image is displayed on the first screen, the object image displayed on the first screen is moved or accelerated in the specific direction by the first movement means. If it is determined by the second determination means that at least part of an object image is displayed on the second screen, the object image displayed on the second screen is moved or accelerated in a direction opposite to the specific direction by the second movement means.

Hence, when sound is detected with an object image being displayed only on the first screen, the object image is moved or accelerated in the specific direction. When sound is detected with an object image being displayed only on the second screen, the object image is moved or accelerated in a direction opposite to the specific direction. When sound is detected with object images being displayed on both the first screen and the second screen, the object image on the first screen is moved or accelerated in the specific direction and the object image on the second screen is moved or accelerated in the direction opposite to the specific direction.

According to the seventh invention, by the player blowing his/her breath on the center of an object from the front, for example, the player can obtain a realistic operation feeling as if he/she actually blew off the object.

A game apparatus according to an eighth invention depends from the seventh invention, and the display control means may further include an addition means (S31) for adding a movement component of a direction perpendicular to the specific direction, to movement made by the first movement means and/or movement made by the second movement means. The addition means may add a leftward movement component to an object image displayed on a left side of the microphone relative to the specific direction and add a rightward movement component to an object image displayed on a right side of the microphone relative to the specific direction.

In the eighth invention, a movement component of a direction perpendicular to the specific direction (i.e., a leftward direction or a rightward direction relative to the specific direction) is added by the addition means to movement made by the first movement means (i.e., movement in the specific direction) and/or movement made by the second movement means (i.e., movement in the direction opposite to the specific direction). Which one of the leftward and rightward movement components is added is determined by the positional relationship between an object image and the microphone. Specifically, a leftward movement component is added to an object image displayed on the left side of the microphone relative to the specific direction, and a rightward movement component is added to an object image displayed on the right side of the microphone relative to the specific direction.

According to the eighth invention, a more realistic operation feeling can be obtained.

A game apparatus according to a ninth invention depends from any one of the first to eighth inventions, and may be a handheld game apparatus and further comprise: a first housing (16a) for accommodating the first screen; a second housing (16b) for accommodating the second screen; and a coupling portion (16H) that foldably couples the first housing to the second housing, and the microphone may be provided to the coupling portion.

In the ninth invention, the first screen and the second screen are accommodated in the first housing and the second housing, respectively, and the microphone is provided to the coupling portion that foldably couples the two housings together.

The coupling portion allows the first housing and the second housing to rotate relative to each other, and can switch between a folded state and an open state (a state in which the first screen and the second screen are disposed in line). Here, the rotation may be single-axis rotation or two-axis rotation.

According to the ninth invention, in a folding type game apparatus, a natural operation feeling can be obtained while the accuracy of a sound operation is increased. Furthermore, the game apparatus can be made compact as compared with a case where a microphone is provided to the first housing or the second housing.

A game apparatus according to a tenth invention depends from the ninth invention, and the microphone may be provided at a center of the coupling portion.

According to the tenth invention, advantageous effects that a natural operation feeling can be obtained while the accuracy of a sound operation is increased can be magnified as much as possible.

A game apparatus according to an eleventh invention depends from the ninth invention, and the coupling portion may have a first coupling portion (16H1) and a second coupling portion (16H2). The first coupling portion is fixedly provided to an upper housing that is the first housing. The second coupling portion is connected to the first coupling portion so as to be rotatable relative to the first coupling portion and is fixedly provided to a lower housing that is the second housing. The microphone may be disposed at the first coupling portion.

A game apparatus according to a twelfth invention depends from the eleventh invention, and the display control means may be an electronic circuit board (40) and the electronic circuit board may be accommodated in the second housing. The game apparatus may further comprise a first conducting wire (L1) that connects the microphone to the electronic circuit board. The first conducting wire may be wired so as to pass through an inside of the first coupling portion and be incorporated inside the second housing from one end (16Hb) of the first coupling portion.

According to the twelfth invention, since the first conducting wire that connects the microphone to the electronic circuit board does not hinder pivoting of the coupling portion, smooth opening and closing of the two housings can be performed.

A game apparatus according to a thirteenth invention depends from the twelfth invention, and may further comprise a second conducting wire (L2) that connects the first screen to the electronic circuit board. The second conducting wire may be wired so as to pass through the inside of the first coupling portion and be incorporated inside the second housing from the one end (16Hb) of the first coupling portion, and the one end through which the first conducting wire passes may be same as the one end through which the second conducting wire passes.

According to the thirteenth invention, since the first conducting wire and the second conducting wire are led into the second housing from one same end of the first coupling portion, a lead-in port in the second housing can be shared between the two conducting wires and thus the structure of the second housing can be simplified.

A game apparatus according to a fourteenth invention comprises a first screen (12), a second screen (14), an electronic circuit board (40), a first housing (16a), a second housing (16b), a hinge (16H), a microphone (34), and a first conducting wire (L1). The first housing accommodates the first screen and the second housing accommodates the second screen and the electronic circuit board. The hinge connects the first housing to the second housing and the microphone is provided to the hinge. The first conducting wire connects the microphone to the electronic circuit board. The hinge is integrally formed with the first housing, and the first conducting wire is wired so as to pass through an inside of the hinge and be incorporated inside the second housing from one end (16Hb) of the hinge.

In the fourteenth invention, the first screen is accommodated in the first housing and the second screen and the electronic circuit board are accommodated in the second housing. The microphone is provided to the hinge that connects the first housing to the second housing, and is connected to the electronic circuit board by the first conducting wire. The hinge is integrally formed with the first housing and thus the first conducting wire is wired so as to pass through the inside of the hinge and be incorporated inside the second housing from one end of the hinge.

According to the fourteenth invention, a folding type game apparatus can be implemented, which is capable of displaying game images on two screens and in which a sound operation can be performed. In the game apparatus, since the first conducting wire that connects the microphone to the electronic circuit board does not hinder pivoting of the hinge, smooth opening and closing of the two housings can be performed. In addition, since the microphone is located between the first screen and the second screen, when playing a game in which a game image including an object image is displayed on at least one of the first screen and the second screen and the object image is changed when a specific sound wave is detected by the microphone, a natural operation feeling can be obtained while the accuracy of a sound operation is increased.

A game apparatus according to a fifteenth invention depends from the fourteenth invention, and may further comprise a second conducting wire (L2) that connects the first screen to the electronic circuit board. The second conducting wire may be wired so as to pass through the inside of the hinge and be incorporated inside the second housing from the one end (16Hb) of the hinge. The one end through which the first conducting wire passes may be same as the one end through which the second conducting wire passes.

According to the fifteenth invention, since the first conducting wire and the second conducting wire are led into the second housing from one same end of the hinge, a lead-in port in the second housing can be shared between the two conducting wires and thus the structure of the second housing can be simplified.

A game apparatus according to a sixteenth invention depends from the fourteenth or fifteenth invention, and the microphone may be provided at a center of the hinge.

According to the sixteenth invention, advantageous effects that a natural operation feeling can be obtained while the accuracy of a sound operation is increased can be magnified as much as possible.

A game apparatus according to a seventeenth invention is a handheld game apparatus (10) that can removably mount media (26) storing game programs. The game apparatus comprises: a first screen (12) and a second screen (14), on at least one of which is displayed a game image including an object image; a first housing (16a) that accommodates the first screen; a second housing (16b) that accommodates the second screen; a coupling portion (16H) that foldably couples the first housing to the second housing; a microphone (34) provided to the coupling portion; and a processing means (42) for executing the game programs stored in the mounted media. A first medium that is one of the media stores therein a first program and a second medium that is other one of the media stores therein a second program. The first program causes the processing means to perform a processing of displaying a game object on the first display screen and controlling an action of the game object according to a sound input by the microphone. The second program causes the processing means to perform a processing of displaying a game object on the second display screen and controlling an action of the game object according to a sound input by the microphone.

In the seventeenth invention, when the first medium storing the first program is mounted, a game object is displayed on the first screen and when the second medium storing the second program is mounted, a game object is displayed on the second screen. In either case, although a sound operation is performed on the displayed object through the microphone, since the microphone is located between the first screen and the second screen, the accuracy of a sound operation improves and a natural operation feeling can be obtained.

A game apparatus according to an eighteenth invention is a handheld game apparatus (10) that can removably mount a medium (26) storing a game program. The game apparatus comprises: a first screen (12) and a second screen (14), on at least one of which is displayed a game image including an object image; a first housing (16a) that accommodates the first screen; a second housing (16b) that accommodates the second screen; a coupling portion (16H) that foldably couples the first housing to the second housing; a microphone (34) provided to the coupling portion; and a processing means (42) for executing the game program stored in the mounted medium. The medium stores therein a first program and a second program and the processing means selectively runs one of the first program and the second program. The first program causes the processing means to perform a processing of displaying a game object on the first display screen and controlling an action of the game object according to a sound input by the microphone. The second program causes the processing means to perform a processing of displaying a game object on the second display screen and controlling an action of the game object according to a sound input by the microphone.

In the eighteenth invention, the first program and the second program are stored in a medium and when the first program is run, a game object is displayed on the first screen and when the second program is run, a game object is displayed on the second screen. In either case, although a sound operation is performed on the displayed object through the microphone, since the microphone is located between the first screen and the second screen, the accuracy of a sound operation improves and a natural operation feeling can be obtained.

A game program according to a nineteenth invention causes a computer (42) of a game apparatus (10) having a first screen (12), a second screen (14), and a microphone (34) provided between the first screen and the second screen, to perform: a display step (S3) of displaying a game image including an object image (80, 84) on at least one of the first screen and the second screen; and a display control step (S9) of changing, when sound is detected through the microphone, the object image displayed in the display step.

In the nineteenth invention too, as with the first invention, the accuracy of a sound operation improves and a natural operation feeling can be obtained.

According to the present invention, the accuracy of a sound operation can be increased, and moreover, a natural operation feeling can be obtained with respect to an object displayed on a screen.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing an external appearance of one embodiment of the present invention;

FIG. 2 is an illustrative view showing a folded state of the embodiment of FIG. 1;

FIG. 3 is an illustrative view showing a cross-section of a hinge applied to the embodiment of FIG. 1;

FIG. 4 is a block diagram showing an electrical configuration of the embodiment of FIG. 1;

FIG. 5 is an illustrative view showing a mapping state of a RAM applied to the embodiment of FIG. 1;

FIG. 6 is an illustrative view showing an example of a waveform pattern of a specific sound wave applied to the embodiment of FIG. 1;

FIGS. 7(A) to 7(C) are illustrative views each showing an example of a change in a game screen applied to the embodiment of FIG. 1;

FIGS. 8(A) to 8(C) are illustrative views each showing another example of the change in the game screen applied to the embodiment of FIG. 1;

FIGS. 9(A) to 9(C) are illustrative views each showing still another example of the change in the game screen applied to the embodiment of FIG. 1;

FIGS. 10(A) to 10(C) are illustrative views each showing yet another example of the change in the game screen applied to the embodiment of FIG. 1;

FIG. 11 is a flowchart showing part of a processing operation of a CPU core applied to the embodiment of FIG. 1;

FIG. 12 is a flowchart showing another part of the processing operation of the CPU core applied to the embodiment of FIG. 1; and

FIG. 13 is a flowchart showing still another part of the processing operation of the CPU core applied to the embodiment of FIG. 1.

### DETAILED DESCRIPTION OF THE PREFERRED EMBODIMENTS

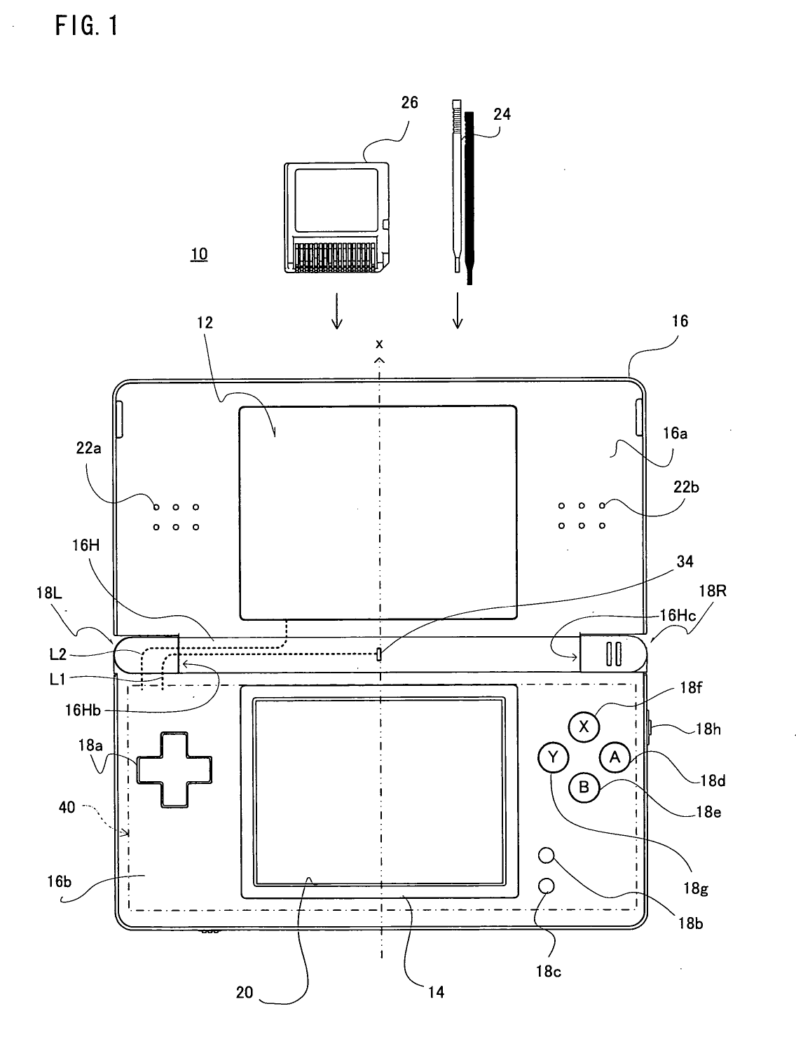

Referring to FIG. 1, a game apparatus 10 that is one embodiment of the present invention includes a first liquid crystal display (LCD) 12 and a second LCD 14. The LCD 12 and the LCD 14 are accommodated in a housing 16 so as to be at predetermined disposition locations. In the present embodiment, the housing 16 is composed of an upper housing 16a and a lower housing 16b. The LCD 12 is accommodated in the upper housing 16a and the LCD 14 is accommodated in the lower housing 16b. Thus, the LCD 12 and the LCD 14 are disposed in proximity to each other so as to be aligned vertically (above and below) (in other words, in order of the LCD 14 and the LCD 12 along a principal axis direction x).

Although in the present embodiment LCDs are used as displays, EL (electroluminescence) displays or the like may be used instead of LCDs.

As can be seen from FIG. 1, the upper housing 16a has a planar shape larger than a planar shape of the LCD 12 and has an opening formed so as to expose a display surface of the LCD 12 from one principal surface. The lower housing 16b is formed such that its planar shape is comparable to that of the upper housing 16a, and has an opening formed at substantially the center in a lateral direction of the lower housing 16b so as to expose a display surface of the LCD 14. The upper housing 16a has sound release holes 22a and sound release holes 22b formed on the right side and the left side, respectively, in a left-right symmetric manner so as to sandwich the LCD 12. The housing 16 has operation switches 18 (18a, 18b, 18c, 18d, 18e, 18f, 18g, 18h, 18L, and 18R) disposed thereon.

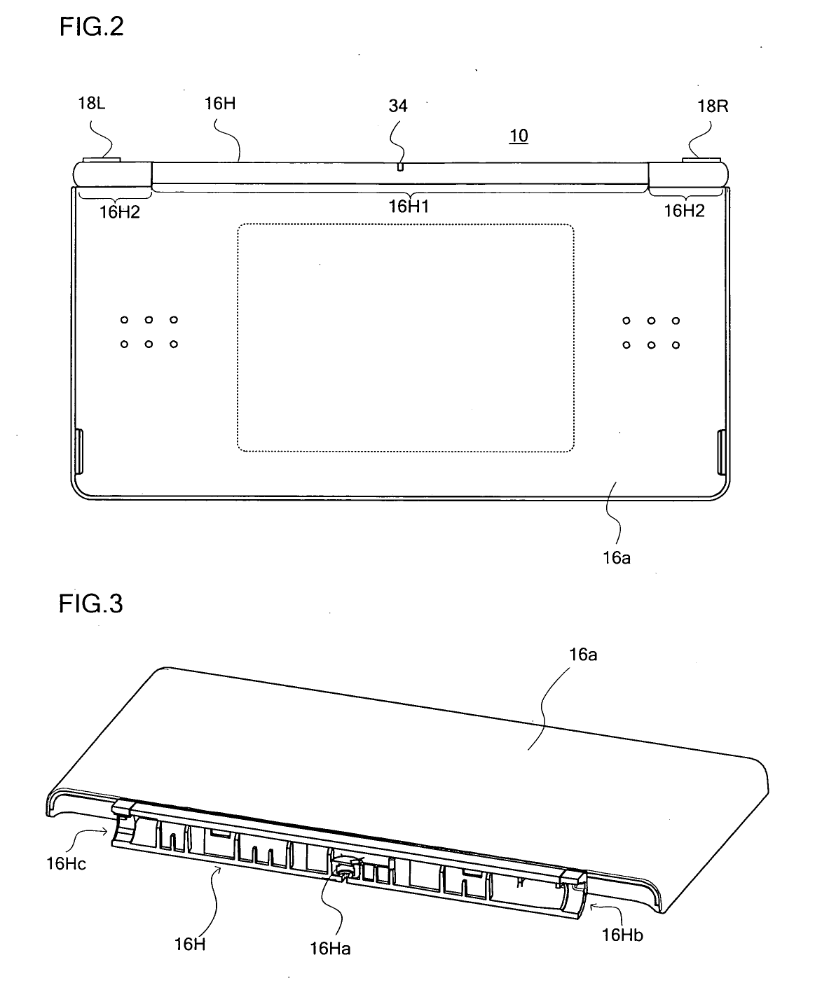

The upper housing 16a and the lower housing 16b are coupled together such that part of a lower hem (lower end) of the upper housing 16a and part of an upper hem (upper end) of the lower housing 16b can pivot via a hinge 16H. The hinge 16H is composed of a first coupling member 16H1 and second coupling members 16H2 (see also FIG. 2). The first coupling member 16H1 is fixedly provided to the upper housing 16a. The second coupling members 16H2 are connected to the first coupling member 16H1 so as to be rotatable relative to the first coupling member 16H1, and are fixedly provided to the lower housing 16b. A microphone 34 is disposed at the first coupling member 16H1.

Thus, when, for example, a game is not played, by pivoting and folding the upper housing 16a such that the display surface of the LCD 12 faces the display surface of the LCD 14 (see FIG. 2), it is possible to prevent the display surface of the LCD 12 and the display surface of the LCD 14 from being damaged, such as with flaws, and the game apparatus 10 can be made compact when not in use. Note that the upper housing 16a and the lower housing 16b may not be pivotably coupled together and a housing 16 in which they are integrally (fixedly) provided may be formed.

The operation switches 18 include a direction instruction switch (cross switch) 18a, a start switch 18b, a select switch 18c, an action switch (A button) 18d, an action switch (B button) 18e, an action switch (X button) 18f, an action switch (Y button) 18g, a power switch 18h, an action switch (L button) 18L, and an action switch (R button) 18R. The switch 18a is disposed on the left side of the LCD 14 of one principal surface of the lower housing 16b. The switch 18h is disposed at a right side surface of the lower housing 16b. The switches 18b to 18g are disposed on the right side of the LCD 14 of the one principal surface of the lower housing 16b. The switches 18L and 18R are disposed at portions on the left and right of a top end (upper surface) of the lower housing 16b, respectively, so as to sandwich a portion coupling the lower housing 16b and the upper housing 16a together.

The direction instruction switch 18a functions as a digital joystick. The direction instruction switch 18a is used, for example, to instruct the moving direction of a player character (or a player object) that can be operated by a player or the moving direction of a cursor, by operating one of four pressing portions. The start switch 18b is composed of a push button and used, for example, to start (resume) or pause a game. The select switch 18c is composed of a push button and used, for example, to select a game mode.

The action switch 18d, i.e., the A button, is composed of a push button and allows the player to perform operations other than a direction instruction, i.e., allows a player character to perform arbitrary actions such as hitting (punching), throwing, catching (obtaining), riding, and jumping. For example, in an action game, instructions such as jumping, punching, and moving a weapon can be made. In a role playing game (RPG) or simulation RPG, instructions such as obtaining an item and selecting and determining a weapon or a command can be made. The action switch 18e, i.e., the B button, is composed of a push button and used, for example, to change a game mode selected by the select switch 18c or cancel an action determined by the A button 18d.

The action switch 18e, i.e., the X button, and the action switch 18f, i.e., the Y button, each are composed of a push button and used as an auxiliary operation button when a game cannot advance only with the push button A and the push button B. Of course, the X button and the Y button do not necessarily need to be used in game play. The power switch 18h is a switch for turning on or off the power of the game apparatus 10.

The action switch 18L (left press button) and the action switch 18R (right press button) each are composed of a push button. The left press button (L button) 18L and the right press button (R button) 18R can be used for the same operations as those performed by the A button 18d and the B button 18e. The left press button 18L and the right press button 18R can also be used for auxiliary operations of the A button 18d and the B button 18e.

The game apparatus 10 is a game apparatus using a touch panel. A touch panel 20 is mounted on a top surface of the LCD 14. For the touch panel 20, a touch panel of any type, including a resistance film type, an optical type (infrared type), and a capacitive coupling type, for example, can be used. By performing an operation on the touch panel 20 by pressing or patting (touching) a top surface of the touch panel 20 with a stick 24, a pen (stylus pen), or a finger (hereinafter, it may be referred to as the “stick 24 or the like”), the touch panel 20 detects a coordinate location of the stick 24 or the like and outputs coordinate data.

Although in the present embodiment the resolution of the display surface of the LCD 14 (the same or substantially the same applies to the LCD 12) is 228 dots×192 dots and the detection accuracy of the touch panel 20 is also 228 dots×192 dots so as to correspond with the display surface, the detection accuracy of the touch panel 20 may be lower or higher than the resolution of the display surface.

As such, the game apparatus 10 has the LCD 12 and the LCD 14 that serve as display portions of the two screens and the touch panel 20 is provided on a display screen of any one of the LCDs 12 and 14 (the LCD 14 in the present embodiment), and thus, the game apparatus 10 has two screens (the LCDs 12 and 14) and two-system operation portions (18 and 20).

In the present embodiment, the stick 24 can be accommodated in an accommodating portion (accommodating slot) (not shown) provided at a location on the upper housing 16a situated nearer a side surface (right) in relation to the center, for example, and is taken out where necessary. Note, however, that when the stick 24 is not provided, there is no need to provide the accommodating portion.

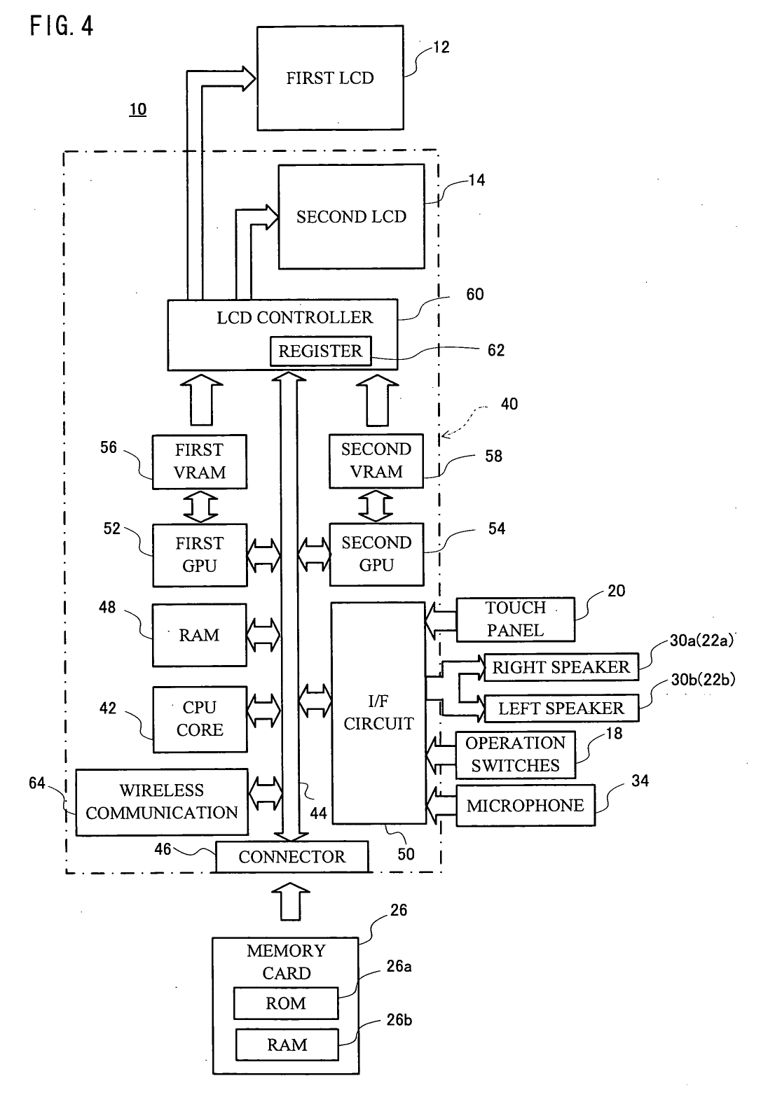

The game apparatus 10 includes a memory card (or a game cartridge) 26. The memory card 26 is removable and inserted from an insertion slot (not shown) provided in a rear side or top end (side surface) of the lower housing 16b. Though not shown in FIG. 1, a connector 46 (see FIG. 4) for joining to a connector (not shown) provided at an end in an insertion direction of the memory card 26 is provided at an inner end of the insertion slot. Thus, when the memory card 26 is inserted into the insertion slot, the connectors are joined to each other, whereby a CPU core 42 (see FIG. 2) of the game apparatus 10 can access the memory card 26.

Furthermore, the game apparatus 10 includes the microphone 34. The microphone 34 is provided at the center of the hinge 16H, for example. Specifically, referring to FIG. 3, the hinge 16H is formed integrally with the upper housing 16a and has a hollow structure. A microphone accommodating portion 16Ha for accommodating the microphone 34 is formed in the center of the hinge 16H.

Referring back to FIG. 1, the microphone 34 provided in the center of the hinge 16H is connected, through a conducting wire L1, to an electronic circuit board 40 (see FIG. 4; which will be described later) of the game apparatus 10. Since the electronic circuit board 40 is accommodated in the lower housing 16b, the conducting wire L1 is wired so as to pass through the inside of the hinge 16H and be incorporated inside the lower housing 16b from one end 16Hb of the hinge 16H. A conducting wire L2 for connecting the LCD 12 accommodated in the upper housing 16a to the electronic circuit board 40 is also wired so as to pass through the inside of the hinge 16H and be incorporated inside the lower housing 16b from the one end 16Hb. The LCD 14 is provided directly to the electronic circuit board 40.

Thus, when, for example, sound (sound made by the player or user giving utterance or blowing his/her breath) is inputted from the microphone 34, the game apparatus 10 performs game processing according to the sound input and can change a game image(s) displayed on the LCD 12 and/or the LCD 14.

Though not described in FIG. 1, a right speaker 30b is provided at a location in the upper housing 16a corresponding to where the sound release holes 22a of the upper housing 16a are provided, and a left speaker 30a is provided at a location in the upper housing 16a corresponding to where the sound release holes 22b are provided (see FIG. 4).

Though not shown in FIG. 1, for example, a battery accommodating box is provided on the rear side of the lower housing 16b and a volume control knob, an external extension connector, an earphone jack, and the like, are provided on a bottom side of the lower housing 16b.

FIG. 4 is a block diagram showing an electrical configuration of the game apparatus 10. Referring to FIG. 4, the game apparatus 10 includes the electronic circuit board 40. Circuit components such as the CPU core 42 are placed on the electronic circuit board 40. The CPU core 42 is connected, via a bus 44, to the connector 46, a RAM 48, a first GPU (Graphics Processing Unit) 52, a second GPU 54, an I/F circuit 50, an LCD controller 60, and a wireless communication unit 64.

As described above, the memory card 26 is removably connected to the connector 46. The memory card 26 includes a ROM 26a and a RAM 26b. Though not shown, the ROM 26a and the RAM 26b are connected to each other via a bus and are connected to a connector (not shown) that is joined to the connector 46. As a result, the CPU core 42 can access the ROM 26a and the RAM 26b.

The ROM 26a stores therein in advance a game program for a game to be performed on the game apparatus 10, image data such as character images, background images, item images, and message images, and sound data such as sound effects, BGM, and imitative sounds of characters. The RAM 26b saves midway data and result data on a game.

The RAM 48 is used as a buffer memory or a working memory. Specifically, the CPU core 42 loads a game program and data such as image data and sound data that are stored in the ROM 26a of the memory card 26, into the RAM 48 and executes the loaded game program. The CPU core 42 stores in the RAM 48 temporary data, such as game data and flag data, according to the progress of game processing.

Note that a game program and data such as image data and sound data are read from the ROM 26a at once or partially and sequentially where needed, and stored in the RAM 48.

The GPUs 52 and 54 each form part of a rendering means and are composed of a single chip ASIC, for example. When the GPU 52 or 54 receives a graphics command (image forming instruction) from the CPU core 42, the GPU 52 or 54 generates game image data according to the graphics command. Here, the CPU core 42 provides to the GPUs 52 and 54 an image generation program (included in a game program) necessary to generate the game image data, in addition to the graphics command.

Data (image data such as polygons and textures) necessary to execute the graphics command is stored in the RAM 48 and is obtained by the GPU 52 or 54.

A first VRAM 56 is connected to the GPU 52 and a second VRAM 58 is connected to the GPU 54. The GPU 52 renders generated game image data in the VRAM 56 and the GPU 54 renders generated game image data in the VRAM 58.

The VRAMs 56 and 58 are connected to an LCD controller 60. The LCD controller 60 includes a register 62. The register 62 is composed of one bit, for example, and stores a data value of “0” or “1” by an instruction from the CPU core 42. When the data value of the register 62 is “0”, the LCD controller 60 outputs game image data rendered in the VRAM 56 to the LCD 14 and outputs game image data rendered in the VRAM 58 to the LCD 12. When the data value of the register 62 is “1”, the LCD controller 60 outputs game image data rendered in the VRAM 56 to the LCD 12 and outputs game image data rendered in the VRAM 58 to the LCD 14.

The operation switches 18, the touch panel 20, the right speaker 30a, the left speaker 30b, and the microphone 34 are connected to the I/F circuit 50. Here, the operation switches 18 include the above-described switches 18a, 18b, 18c, 18d, 18e, 18f, 18g, 18h, 18L, and 18R. When any of the operation switches 18 is operated, a corresponding operation signal (operation data) is inputted to the CPU core 42 through the I/F circuit 50. Coordinate data detected by the touch panel 20 is also inputted to the CPU core 42 through the I/F circuit 50. The CPU core 42 reads from the RAM 48 sound data necessary for a game, such as BGM, sound effects, or an imitative sound of a character, and outputs the read sound data to the right speaker 30a and the left speaker 30b through the I/F circuit 50. Furthermore, sound (sound signal) inputted from the microphone 34 is converted into digital data (sound data) by the I/F circuit 54 and the digital data is inputted to the CPU core 42.

In a state in which a match mode is selected, a radio signal is exchanged between the game apparatus 10 and a game apparatus of an opponent through the wireless communication unit 64. That is, the wireless communication unit 64 modulates communication data to be transmitted to the opponent into a radio signal and transmits the radio signal from an antenna (not shown), and receives by the same antenna a radio signal to be transmitted from the game apparatus of the opponent and demodulates the radio signal into communication data.

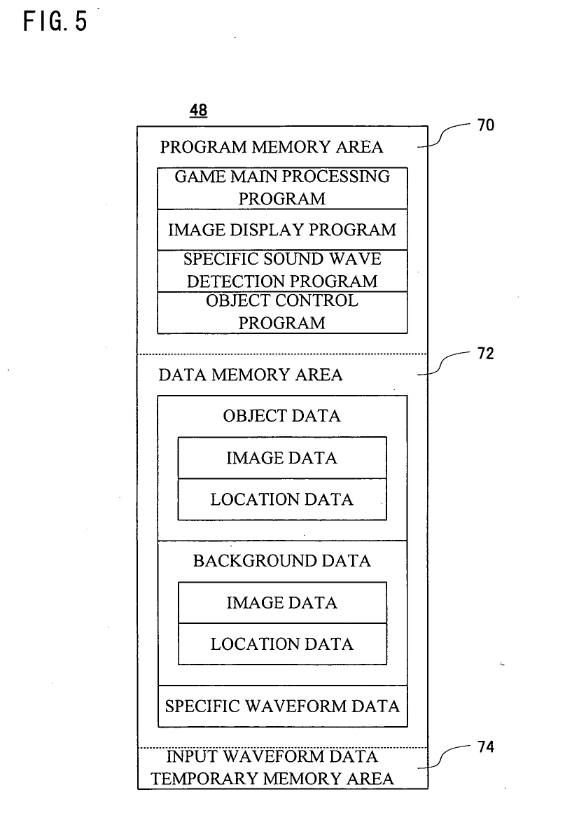

FIG. 5 shows an example of a memory map of the RAM 48. The RAM 48 includes a program memory area 70 that stores programs loaded from the ROM 26a of the memory card 26. The programs to be loaded include a game main processing program, an image display program, a specific sound wave detection program, an object control program, and the like.

The game main processing program is a program for performing main processing for playing a game, e.g., a processing of accepting an input operation, a processing of advancing the game according to an input operation, and a processing of computing points or determining a win or a loss, based on game results. The image display program is a program for displaying a game image(s) on one or both of the LCDs 12 and 14. The specific sound wave detection program is a program for detecting a sound wave having a specific waveform pattern. The object control program is a program for moving an object image included in a game image displayed by the image display program, in response to a detection processing by the specific sound wave detection program.

The RAM 48 includes a data memory area 72. The data memory area 72 stores therein object data, background data, specific waveform data, and the like. The object data is composed of image data and location data and the background data is also composed of image data and location data. By the image display program performing a rendering based on the object data and the background data, a game image(s) is (are) displayed on the LCD 12 and/or the LCD 14.

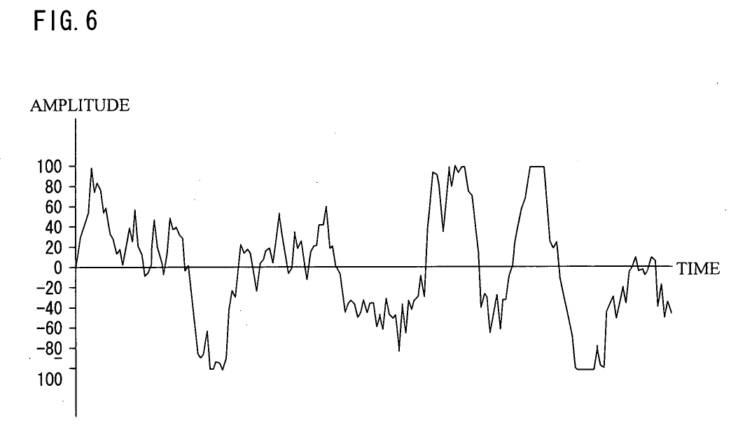

The specific waveform data indicates a specific waveform pattern, here, a waveform pattern of a sound wave to be generated when breath is blown on the microphone 34. An example of such a waveform pattern is shown in FIG. 6. For the specific waveform data, data indicating a waveform pattern itself or data indicating the characteristics (e.g., frequency distribution) of a waveform pattern may be used.

The RAM 48 further includes an input waveform data temporary memory area 74. In the input waveform data temporary memory area 74, input waveform data indicating a waveform (or characteristics of a waveform) of sound inputted from the microphone 34 is temporarily stored.

Specifically, when sound is inputted from the microphone 34, the specific sound wave detection program generates input waveform data from the inputted sound. The generated input waveform data is temporarily stored in the input waveform data temporary memory area 74. The specific sound wave detection program checks the input waveform data against the specific waveform data in the data memory area 72 and determines, when a check result satisfies a matching condition, that a specific sound wave has been detected. In response to the detection of the specific sound wave, the object control program updates the location data included in the object data, whereby the object image included in the game image moves.

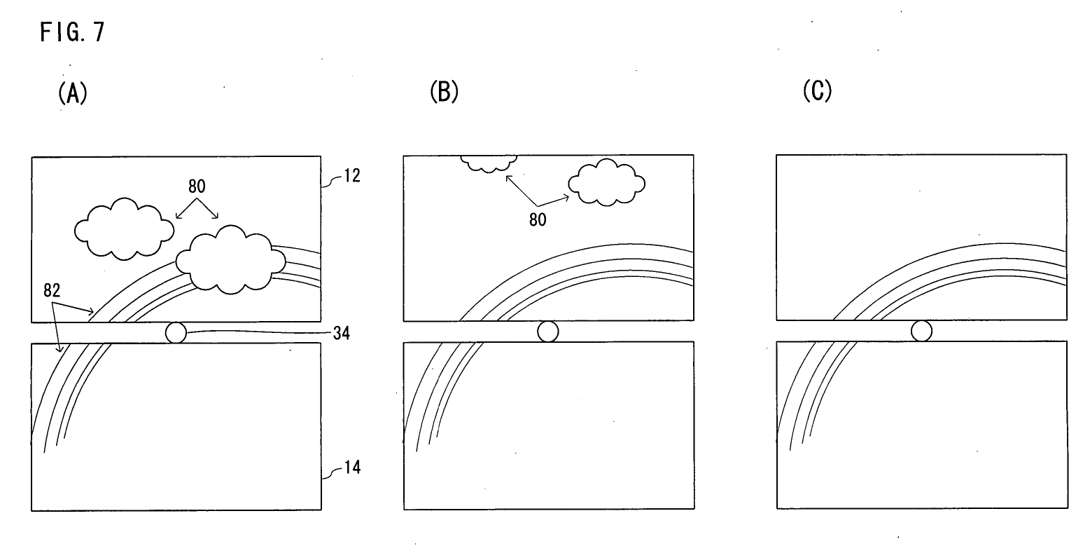

One scene of a game to be played on the game apparatus 10 configured in the above-described manner is shown in FIGS. 7(A) to 7(C). In the scene, a game image includes clouds 80 as object images and a rainbow 82 as a background image. In the scene, at an initial stage, as shown in FIG. 7(A), the clouds 80 are displayed only on the LCD 12 and the rainbow 82 is displayed across the LCDs 12 and 14.

When, in the state of FIG. 7(A), the player blows his/her breath on the clouds 80 on the LCD 12, the breath hits the microphone 34, and as a result, a sound wave is generated by the microphone 34. The generated sound wave is captured by the microphone 34 itself and the CPU core 42 senses from a waveform of the captured sound wave that the breath has been blown. In response to this, as shown in FIGS. 7(A) to 7(C), the clouds 80 on the LCD 12 move upward (i.e., a principal axis direction x; a direction going from the LCD 14 to the LCD 12).

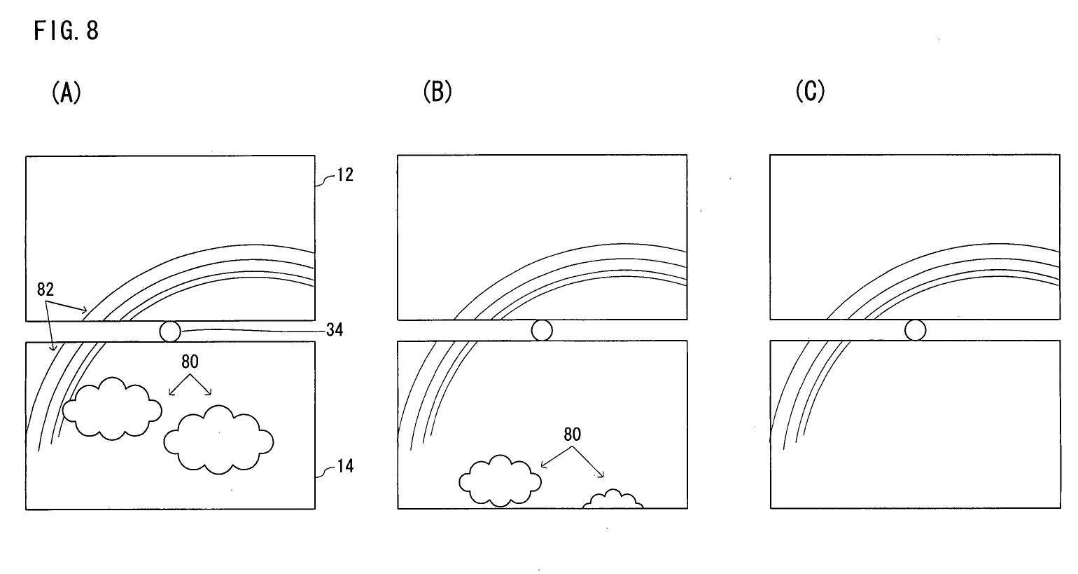

Another scene of the game is shown in FIGS. 8(A) to 8(C). In the scene, a game image includes clouds 80 as object images and a rainbow 82 as a background image. In the scene, at an initial stage, as shown in FIG. 8(A), the clouds 80 are displayed only on the LCD 14 and the rainbow 82 is displayed across the LCDs 12 and 14.

When, in the state of FIG. 8(A), the player blows his/her breath on the clouds 80 on the LCD 14, the breath hits the microphone 34, and as a result, a sound wave is generated by the microphone 34. The generated sound wave is captured by the microphone 34 itself and the CPU core 42 senses from a waveform of the captured sound wave that the breath has been blown. In response to this, as shown in FIGS. 8(A) to 8(C), the clouds 80 on the LCD 14 move downward (i.e., a direction opposite to the principal axis direction x).

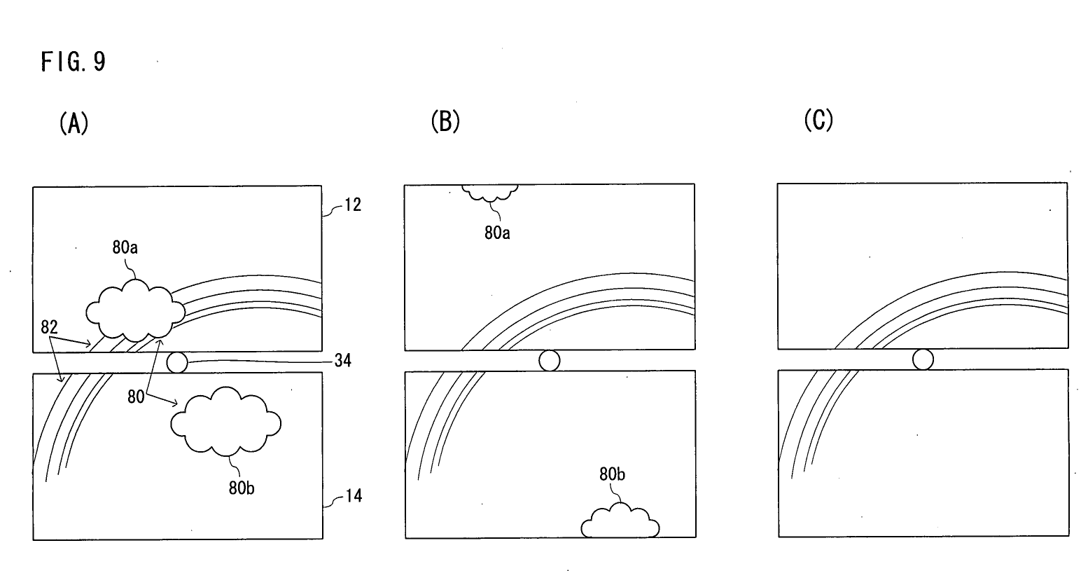

Still another scene of the game is shown in FIGS. 9(A) to 9(C). In the scene, a game image includes clouds 80 as object images and a rainbow 82 as a background image. In the scene, at an initial stage, as shown in FIG. 9(A), the clouds 80 are displayed on both of the LCDs 12 and 14 and the rainbow 82 is displayed across the LCDs 12 and 14.

When, in the state of FIG. 9(A), the player blows his/her breath on the clouds 80 on the LCDs 12 and 14, the breath hits the microphone 34, and as a result, a sound wave is generated by the microphone 34. The generated sound wave is captured by the microphone 34 itself and the CPU core 42 senses from a waveform of the captured sound wave that the breath has been blown. In response to this, as shown in FIGS. 9(A) to 9(C), a cloud 80a on the LCD 12 moves upward and a cloud 80b on the LCD 14 moves downward. Note that the clouds 80 do not need to move linearly upward and downward and may move, as a whole, upward and downward along a curve, such as a parabola, or a certain track. When the cloud 80a is in the processing of moving downward, the moving speed in the downward direction of the cloud 80a may be reduced by an input to the microphone.

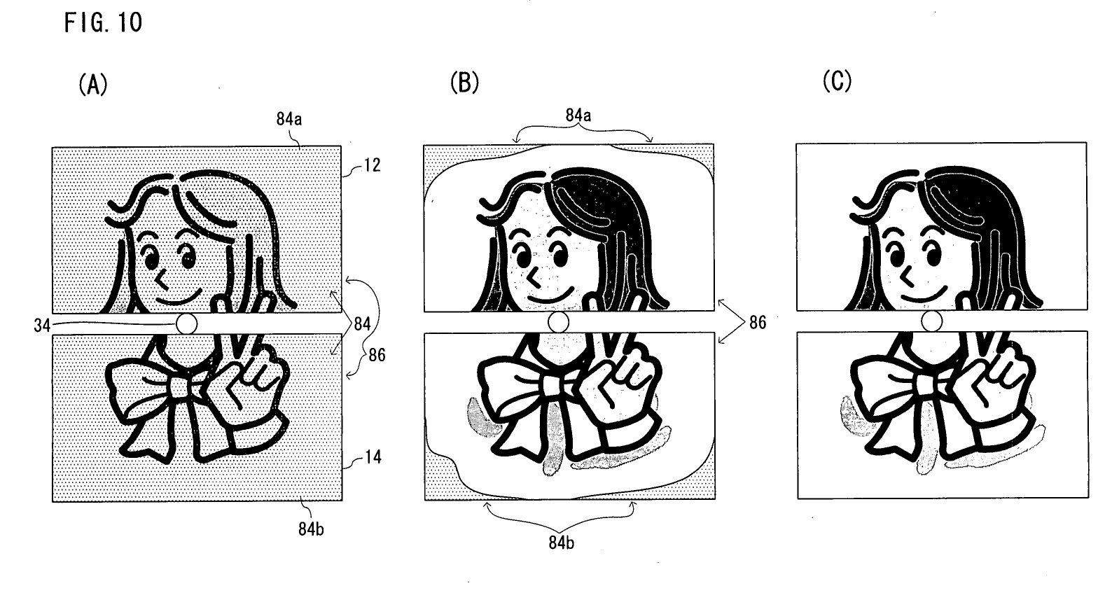

A yet another scene of the game is shown in FIGS. 10(A) to 10(C). In the scene, a game image includes dust 84 as an object image and a portrait (a painting or photograph) 86 as a background image. In the scene, at an initial stage, as shown in FIG. 10(A), the dust 84 is displayed across the LCDs 12 and 14 and the portrait 86 is also displayed across the LCDs 12 and 14.

When, in the state of FIG. 10(A), the player blows his/her breath on the center of the dust 84 displayed across the LCDs 12 and 14, i.e., on the microphone 34 present between the LCDs 12 and 14, the breath hits the microphone 34, and as a result, a sound wave is generated by the microphone 34. The generated sound wave is captured by the microphone 34 itself and the CPU core 42 senses from a waveform of the captured sound wave that the breath has been blown. In response to this, as shown in FIGS. 10(A) to 10(C), dust 84a on the LCD 12 moves upward and dust 84b on the LCD 14 moves downward.

As can be seen from the above four scenes, by disposing the microphone 34 at the center of the hinge 16H, the distance between arbitrary points on the two LCDs 12 and 14 and the microphone 34 is reduced as much as possible; as a result, when playing a game in which a game image including an object image is displayed on at least one of the LCDs 12 and 14 and the object image is changed upon detection of a specific sound wave by the microphone 34, a natural operation feeling can be obtained while the accuracy of a sound operation is increased.

In addition, in any of the scenes, leftward motion is added to an object image located on the left side of the microphone 34 and rightward motion is added to an object image located on the right side of the microphone 34; as a result, a more natural operation feeling can be obtained.

In a scene in which clouds 80 are blown off, by gradually reducing the sizes of the clouds 80 along movements in the upward and downward directions, a further natural operation feeling can be obtained.

A program that executes a mode of FIG. 7 and a program that executes a mode of FIG. 8 may be stored on different memory cards 26, respectively, or may be stored on a single memory card 26. In the latter case, one of the programs is selectively run.

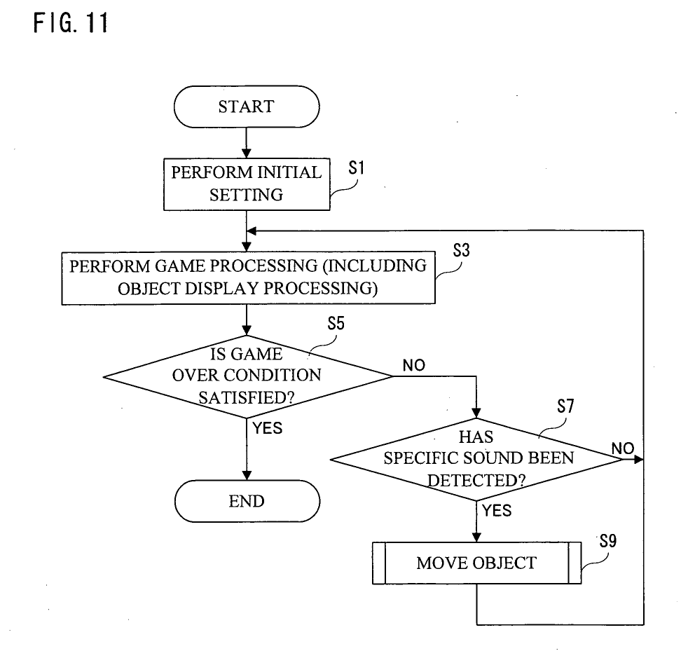

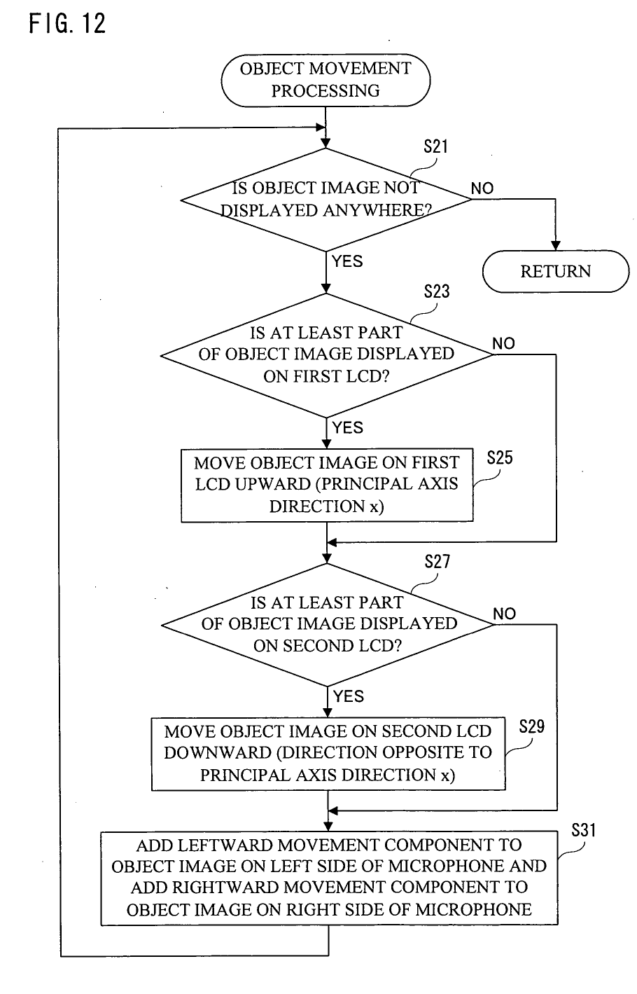

When playing a game on the game apparatus 10, the CPU core 42 performs processing according to flowcharts shown in FIGS. 11 and 12. First, referring to FIG. 11, an initial setting is performed in a step S1. Specifically, initialization of variables and flags to be used in game processing, clearing of a buffer and a register, and the like, are performed. Once an initialization processing has been completed, the processing proceeds to a step S3.

In the step S3, game processing is performed. Specifically, a processing of displaying a game image, i.e., an object image and a background image, on the LCD 12 and/or the LCD 14, a processing of accepting an input operation through any of the operation switches 18, the microphone 34, or the like, a processing of advancing the game in predetermined steps according to an input operation, a processing of computing points or determining a win or a loss, in predetermined steps based on game results, and the like, are performed.

In a subsequent step S5, it is determined whether a game over condition is satisfied. If YES, the processing ends. If NO, the processing proceeds to a step S7, and it is further determined whether a specific sound has been detected. Specifically, this determination is made according to the following steps. When sound is inputted from the microphone 34, data indicating a waveform (or characteristics of a waveform) of an inputted sound.wave is generated in the main processing in the step S3, and the generated input waveform data is temporarily stored in the RAM 48 (see FIG. 4). The input waveform data temporarily stored in the RAM 48 is checked against specific waveform data that is stored in advance in the RAM 48. Then, when a check result satisfies a matching condition, it is determined that a specific sound has been detected.

If NO in the step S7, the processing returns to the step S3, while if YES, the processing proceeds to a step S9. In the step S9, the object image included in the game image is moved, i.e., location data that composes object data in the data memory area 72 is updated. Thereafter, the processing returns to the step S3.

The object movement processing in the step S9 is, specifically, performed according to the flow of FIG. 12. Referring to FIG. 12, first, in a step S21, it is determined whether an object image is displayed. If an object image is not displayed anywhere on the LCD 12 or the LCD 14, it is determined to be NO in the step S21 and the processing returns to an upper layer routine.

If YES in the step S21, the processing proceeds to a step S23 and it is determined whether at least part of the object image is displayed on the LCD 12. If YES here the processing proceeds to a step S25, and if NO the step S25 is skipped and the processing proceeds to a step S27.

In the step S25, the object image on the LCD 12 is moved upward (i.e., the principal axis direction x) (i.e., location data on an object is updated). Thereafter, the processing proceeds to the step S27 and it is determined whether at least part of the object image is displayed on the LCD 14. If YES here the processing proceeds to a step S29, and if NO the step S29 is skipped and the processing proceeds to a step S31.

In the step S29, the object image on the LCD 14 is moved downward (i.e., a direction opposite to the principal axis direction x) (i.e., the location data on the object is further updated). Thereafter, the processing proceeds to the step S31 and a leftward movement component is added to the object image on the left side of the microphone 34 and a rightward movement component is added to the object image on the right side of the microphone 34 (i.e., the location data on the object is further updated). After the addition, the processing returns to the step S21.

As is clear from the above, according to the present embodiment, by disposing the microphone 34 between the LCDs 12 and 14, the distance between an object (a cloud 80 or dust 84) displayed on the LCD 12 and/or the LCD 14 and the microphone 34 is reduced; thus, the possibility that detection of a sound wave by a bowing of breath may become difficult depending on the display location of the object can be reduced and the accuracy of a sound operation improves. As a result, the player can perform a sound operation without focusing attention on the microphone 34 (in other words, the player only needs to blow his/her breath on a target to be blown off), and thus, can obtain a natural operation feeling.

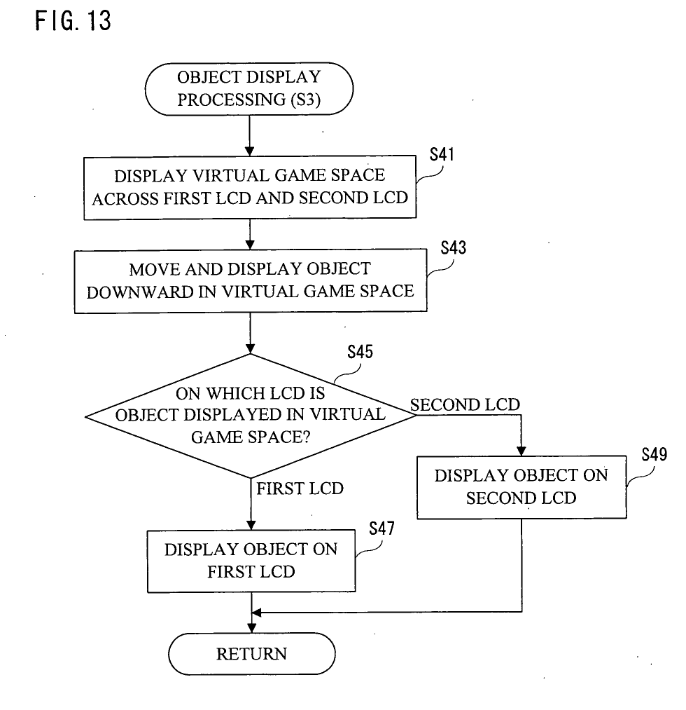

In the present embodiment, objects are normally at rest and when a blowing of breath is detected, an object on the LCD 12 moves downward and an object on the LCD 14 moves downward; however, the objects may be normally in motion. For example, when an object normally moves downward, a flow of FIG. 13 is performed by the CPU core 42 in the game processing in the step S3.

Referring to FIG. 13, in a step. S41, based on the background data (see FIG. 5) in the RAM 48, a virtual game space is displayed across the LCDs 12 and 14. In a step S43, an object is controlled to move downward in the virtual game space. In a step S45, it is determined in which one of display areas of the LCDs 12 and 14 the object is present in the virtual game space. If the object is present in the display area of the LCD 12 in the virtual game space, the processing proceeds to a step S47 and the object image is displayed on the LCD 12. If.the object is present in the display area of the LCD 14, the processing proceeds to a step S49 and the object image is displayed on the LCD 14. In this case, when a blowing of breath is detected, the object on the LCD 12 is accelerated downward.

Although the above describes a case where a sound operation is performed by a blowing of breath, even in a case where a sound operation is performed by utterance, by the distance between an object and the microphone 34 being reduced, the possibility that detection of a specific sound wave may become difficult is reduced and the accuracy of a sound operation improves.

Here, the sound operation by utterance indicates an operation in which by the player pronouncing a command (i.e., generating a sound wave according to a command with vocal cords, lips, or the like), an object is moved or allowed to perform a predetermined action. Thus, a specific sound wave in this case is data indicating a waveform (or characteristics of a waveform) of sound according to the command.

As a result of improvement in accuracy of a sound operation, the player can perform a sound operation without focusing on the microphone 34 (in other words, the player only needs to give utterance in front of an object to be controlled) and thus can obtain a natural operation feeling.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A game apparatus comprising:
a first screen and a second screen, on at least one of which is displayed a game image including an object image;
a microphone; and
a display control means for changing said object image when sound is detected through said microphone, wherein
said microphone is provided between said first screen and said second screen.

2. A game apparatus according to claim 1, wherein
said display control means changes said object image when a specific sound wave is detected through said microphone.

3. A game apparatus according to claim 1, further comprising
an object display means for displaying objects on both of said first screen and said second screen, wherein
said display control means changes both the object image displayed on said first screen and the object image displayed on said second screen, when said sound is detected.

4. A game apparatus according to claim 2, wherein said specific sound wave is a sound wave to be generated by a blowing of breath on said microphone.

5. A game apparatus according to claim 4, wherein
said first screen and said second screen are disposed in order of said second screen and said first screen along a specific direction, and
when said display control means detects said specific sound wave through said microphone, said display control means moves or accelerates said object image displayed on said first screen in said specific direction and moves or accelerates said object image displayed on said second screen in a direction opposite to said specific direction.

6. A game apparatus according to claim 1, further comprising:
a storage means for storing display data for a virtual game space;
a virtual game space display means for displaying said virtual game space across said first screen and said second screen, based on said display data;
an object movement control means for controlling movement of an object in said virtual game space; and
an object display control means for displaying said object image on said first screen when said object is present in a display area of said first screen in said virtual game space, and displaying said object image on said second screen when said object is present in a display area of said second screen.

7. A game apparatus according to claim 1, wherein said first screen and said second screen are disposed in order of said second screen and said first screen along a specific direction, and
said display control means includes:
a first determination means for determining, when said sound is detected through said microphone, whether at least part of said object image is displayed on said first screen;
a first movement means for moving or accelerating, when it is determined by said first determination means that at least part of said object image is displayed on said first screen, said object image displayed on said first screen in said specific direction;
a second determination means for determining, when said sound is detected, whether at least part of said object image is displayed on said second screen; and
a second movement means for moving or accelerating, when it is determined by said second determination means that at least part of said object image is displayed on said second screen, said object image displayed on said second screen in a direction opposite to said specific direction.

8. A game apparatus according to claim 7, wherein
said display control means further includes an addition means for adding a movement component of a direction perpendicular to said specific direction, to movement made by said first movement means and/or movement made by said second movement means, and
said addition means adds a leftward movement component to an object image displayed on a left side of said microphone relative to said specific direction and adds a rightward movement component to an object image displayed on a right side of said microphone relative to said specific direction.

9. A game apparatus according to claim 1, wherein
said game apparatus is a handheld game apparatus,
said game apparatus further comprises:
a first housing for accommodating said first screen;
a second housing for accommodating said second screen; and
a coupling portion that foldably couples said first housing to said second housing, and
said microphone is provided to said coupling portion.

10. A game apparatus according to claim 9, wherein said microphone is provided at a center of said coupling portion.

11. A game apparatus according to claim 9, wherein
said coupling portion has a first coupling portion that is fixedly provided to an upper housing that is said first housing, and a second coupling portion that is connected to said first coupling portion so as to be rotatable relative to said first coupling portion and is fixedly provided to a lower housing that is said second housing, and
said microphone is disposed at said first coupling portion.

12. A game apparatus according to claim 11, wherein
said display control means is an electronic circuit board,
said electronic circuit board is accommodated in said second housing,
said game apparatus further comprises a first conducting wire that connects said microphone to said electronic circuit board, and
said first conducting wire is wired so as to pass through an inside of said first coupling portion and be incorporated inside said second housing from one end of said first coupling portion.

13. A game apparatus according to claim 12, further comprising a second conducting wire that connects said first screen to said electronic circuit board, wherein
said second conducting wire is wired so as to pass through the inside of said first coupling portion and be incorporated inside said second housing from the one end of said first coupling portion, and
the one end through which said first conducting wire passes is same as the one end through which said second conducting wire passes.

14. A game apparatus comprising:
a first screen;
a second screen;
an electronic circuit board;
a first housing that accommodates said first screen;
a second housing that accommodates said second screen and said electronic circuit board;
a hinge that connects said first housing to said second housing;
a microphone provided to said hinge; and
a first conducting wire that connects said microphone to said electronic circuit board, wherein
said hinge is integrally formed with said first housing, and
said first conducting wire is wired so as to pass through an inside of said hinge and be incorporated inside said second housing from one end of said hinge.

15. A game apparatus according to claim 14, further comprising a second conducting wire that connects said first screen to said electronic circuit board, wherein
said second conducting wire is wired so as to pass through the inside of said hinge and be incorporated inside said second housing from the one end of said hinge, and
the one end through which said first conducting wire passes is same as the one end through which said second conducting wire passes.

16. A game apparatus according to claim 14, wherein said microphone is provided at a center of said hinge.

17. A handheld game apparatus that can removably mount media storing game programs, said game. apparatus comprising:
a first screen and a second screen, on at least one of which is displayed a game image including an object image;
a first housing that accommodates said first screen;
a second housing that accommodates said second screen;
a coupling portion that foldably couples said first housing to said second housing;
a microphone provided to said coupling portion; and
a processing means for executing the game programs stored in said mounted media, wherein
a first medium that is one of said media stores therein a first program that causes said processing means to perform a processing of displaying a game object on said first display screen and controlling an action of the game object according to a sound input by said microphone, and
a second medium that is other one of said media stores therein a second program that causes said processing means to perform a processing of displaying a game object on said second display screen and controlling an action of the game object according to a sound input by said microphone.

18. A handheld game apparatus that can removably mount a medium storing a game program, said game apparatus comprising:
a first screen and a second screen, on at least one of which is displayed a game image including an object image;
a first housing that accommodates said first screen;
a second housing that accommodates said second screen;
a coupling portion that foldably couples said first housing to said second housing;
a microphone provided to said coupling portion; and
a processing means for executing the game program stored in said mounted medium, wherein
said storage means stores therein:
a first program that causes said processing means to perform a processing of displaying a game object on said first display screen and controlling an action of the game object according to a sound input by said microphone; and
a second program that causes said processing means to perform a processing of displaying a game object on said second display screen and controlling an action of the game object according to a sound input by said microphone, and
said processing means selectively runs one of said first program and said second program.

19. A medium storing a game program, wherein
said game program causes a computer of a game apparatus having a first screen, a second screen, and a microphone provided between said first screen and said second screen, to perform:
a display step of displaying a game image including an object image on at least one of said first screen and said second screen; and
a display control step of changing, when sound is detected through said microphone, the object image displayed in said display step.
